(19) United States
(12) Patent Application Publication
(10) Pub. No.: US 2026/0154041 A1
(43) Pub. Date: Jun. 4, 2026

(54) SYSTEM AND METHOD FOR AUTOMATED DATA GOVERNANCE BY ASSOCIATION

(71) Applicant: JPMorgan Chase Bank, N.A., New York, NY (US)

(72) Inventors: Jennifer DUENHOELTER, Prosper, TX (US); Shawn RILEY, Plano, TX (US); David POWELL, Tampa, FL (US); Matt MCCLINTOCK, Lantana, TX (US); Syed HUSAIN, Irving, TX (US); Shailesh SINGH, Frisco, TX (US); Amalesh PRADHAN, Plano, TX (US); Katlen GARCIA, Frisco, TX (US)

(73) Assignee: JPMorgan Chase Bank, N.A., New York, NY (US)

(21) Appl. No.: 18/968,326

(22) Filed: Dec. 4, 2024

(51) Int. Cl. G06F 8/20

(52) U.S. Cl. CPC G06F 8/20

(57) ABSTRACT

Various methods and processes, apparatuses/systems, and media for automated data governance are disclosed. A processor creates a data catalog that includes metadata identifying what information to be collected, by whom, and at what stage of each identified phase of a product development life cycle (PDLC) process corresponding to the application; embeds the data catalog, a data governance tool, a continuous integration/continuous delivery (CI/CD) pipeline, and a scheme evolution component into the PDLC process by calling corresponding application programming interface; executes a data governance by association algorithm; and updates the data catalog with schemas based on the data governance by association algorithm. Each data producer and data consumer in connection with the developing, the testing, and the production of the application manages the data governance in synchronization during execution of each identified phases of the PDLC process.

### TECHNICAL FIELD

This disclosure generally relates to data processing, and, more particularly, to methods and apparatuses for implementing a platform, language, cloud, and database agnostic automated data governance module configured for automatic data governance by association.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Today, a wide variety of business functions are commonly supported by software applications and tools, i.e., business intelligence tools. For instance, software has been directed to performance analysis, report generation, project tracking, and competitive analysis, to name but a few. Software development often involves an iterative approach by which different ideas and methodologies may be tested to achieve the best possible outcomes. However, this may result in non-compliance with established frameworks and guidelines. While conventional tools detect bugs, vulnerabilities and code smells, such tools typically fail to enforce frameworks tailored to individual projects. Moreover, in a large software development project involving multiple developers, the testing of various innovative ideas and methodologies to achieve optimal outcomes may sometimes result in non-compliance with project specific established frameworks and guidelines. This situation may be particularly overwhelming for new developers, making it challenging for them to determine which framework to follow.

Data governance is a set of policies, processes, and technologies that ensure data is accurate, secure, and usable throughout its life cycle. It also includes establishing who can access what data, and how it should be used. A product development life cycle (PDLC) process often involves defining, designing, developing, manufacturing, launching, and maintaining a software product. The PDLC is a key part of a business plan that helps software developers understand how software products are developed, tested, and marketed.

However, conventional tools for data governance typically face multiple challenges. For example, control procedures around data governance are misaligned with a PDLC process; each producer/consumer manages data governance separately; sprint teams (a team of members essentially breaking down a larger software development project into manageable chunks and delivering incremental progress) face extra churn, i.e., adding, deleting, or modifying tasks after an initial commitment phase of the sprint, due to lack of information on data sources, classification, and definitions, leading to work spillover, etc. Conventional tools for data governance also face multiple challenges with respect to schema evolution issues. For example, with schema-on-write, producers may write to a predetermined schema but choose a version based on development progress; consumers may upgrade at their own pace, making it more like schema-on-read, leading to potential mismatches and integration challenges, thereby subjecting the overall to systems to potential data security breaches.

Thus, there appears to be a need for an advanced tool that may address the challenges faced by conventional tools in data governance.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic automated data governance module configured for integrating controls into the PDLC process with a focus on a shift-left approach, embedding the governance process into the PDLC process to ensure accountability and highlight dependencies, automatically streamlining data governance by implementing a business tech process of “governance by association”, updating a data catalog upfront with schemas based on the “governance by association,” etc., but the disclosure is not limited thereto.

Thus, the automated data governance module disclosed herein results in technological improvements to conventional data governance tools in that the automated data governance module disclosed herein may be configured to: align control procedures around data governance with the PDLC process; align overall business goals and compliance with regulations, rather than relying solely on a centralized authority to dictate governance; ensure that everyone involved in the PDLC process has a shared responsibility in upholding quality and best practices; provide definition of ready for sprint teams indicating governance information is already available; allow sprint teams to complete work efficiently and automate data ingestion from upstream domains, automate upgrades for new versions, eliminate change tickets in a consumer data lake, support for auto schema evolution, etc., but the disclosure is not limited thereto, thereby improving data security and protecting the overall systems from malicious cyber-attacks.

In some embodiments, a method for automated data governance in a PDLC process is disclosed. The method may include: identifying phases of the PDLC process as a development phase, followed by a testing phase, and followed by a production phase corresponding to developing, testing, and production of an application, respectively; creating a data catalog that includes metadata identifying what information to be collected, by whom, and at what stage of each identified phase of the PDLC process corresponding to the application; establishing a communication link among the data catalog, a data governance tool, a continuous integration/continuous delivery (CI/CD) pipeline, and a schema evolution component via calling corresponding application programming interface; embedding the data catalog, the data governance tool, the CI/CD pipeline, and the scheme evolution component into the PDLC process by calling the corresponding application programming interface; executing a data governance by association algorithm in response to embedding the data catalog, the data governance tool, the CI/CD pipeline, and the scheme evolution component into the PDLC process; and updating the data catalog with schemas based on the data governance by association algorithm, wherein each data producer and data consumer in connection with the developing, the testing, and the production of the application manages the data governance in synchronization during execution of the each identified phases of the PDLC process.

In some embodiments, the data governance tool implements the data governance by association algorithm to ensure accountability and highlight dependencies among the data producer and the data consumer based on the metadata.

In some embodiments, in implementing the data governance by association algorithm, the method may further include: updating the data catalog in corresponding identified phases of the PDLC process in accordance with the schema and the metadata; and aligning control procedures around the data governance with the PDLC process based on the updated data catalog.

In some embodiments, the method may further include: automatically ingesting data from upstream domains of the PDLC process corresponding to the aligned control procedures.

In some embodiments, the method may further include: automatically updating the schema, by calling the schema evolution component via an application programming interface, corresponding to the updated data catalog based on the ingested data from the upstream domains of the PDLC process, thereby ensuring data security and protecting the PDLC process from malicious data breach.

In some embodiments, in implementing the CI/CD pipeline, the method may further include: merging code changes corresponding to the schema identified in the data catalog into a central repository; and calling the central repository via a corresponding application programming interface to retrieve the code changes for utilizing in an identified phase of the PDLC process.

In some embodiments, the method may further include: automatically releasing updates into the development phase, the testing phase, and the production phase of the PDLC process.

In some embodiments, a system for automated data governance in a PDLC process is disclosed. The system may include: a processor; and a memory operatively connected to the processor via a communication interface, the memory storing computer readable instructions, when executed, may cause the processor to: identify phases of the PDLC process as a development phase, followed by a testing phase, and followed by a production phase corresponding to developing, testing, and production of an application, respectively; create a data catalog that includes metadata identifying what information to be collected, by whom, and at what stage of each identified phase of the PDLC process corresponding to the application; establish a communication link among the data catalog, a data governance tool, a CI/CD pipeline, and a schema evolution component via calling corresponding application programming interface; embed the data catalog, the data governance tool, the CI/CD pipeline, and the scheme evolution component into the PDLC process by calling the corresponding application programming interface; execute a data governance by association algorithm in response to embedding the data catalog, the data governance tool, the CI/CD pipeline, and the scheme evolution component into the PDLC process; and update the data catalog with schemas based on the data governance by association algorithm, wherein each data producer and data consumer in connection with the developing, the testing, and the production of the application manages the data governance in synchronization during execution of the each identified phases of the PDLC process.

In some embodiments according to the system, the data governance tool may implement the data governance by association algorithm to ensure accountability and highlight dependencies among the data producer and the data consumer based on the metadata.

In some embodiments, the processor may be further configured to: update the data catalog in corresponding identified phases of the PDLC process in accordance with the schema and the metadata; and align control procedures around the data governance with the PDLC process based on the updated data catalog.

In some embodiments, the processor may be further configured to: automatically ingest data from upstream domains of the PDLC process corresponding to the aligned control procedures.

In some embodiments, the processor may be further configured to automatically update the schema, by calling the schema evolution component via an application programming interface, corresponding to the updated data catalog based on the ingested data from the upstream domains of the PDLC process, thereby ensuring data security and protecting the PDLC process from malicious data breach.

In some embodiments, in implementing the CI/CD pipeline, the processor may be further configured to: merge code changes corresponding to the schema identified in the data catalog into a central repository; and call the central repository via a corresponding application programming interface to retrieve the code changes for utilizing in an identified phase of the PDLC process.

In some embodiments, the processor may be further configured to: automatically release updates into the development phase, the testing phase, and the production phase of the PDLC process.

In some embodiments, a non-transitory computer readable medium configured to store instructions for automated data governance in a PDLC process is disclosed. The instructions, when executed, may cause a processor to perform the following: identifying phases of the PDLC process as a development phase, followed by a testing phase, and followed by a production phase corresponding to developing, testing, and production of an application, respectively; creating a data catalog that includes metadata identifying what information to be collected, by whom, and at what stage of each identified phase of the PDLC process corresponding to the application; establishing a communication link among the data catalog, a data governance tool, a CI/CD pipeline, and a schema evolution component via calling corresponding application programming interface; embedding the data catalog, the data governance tool, the CI/CD pipeline, and the scheme evolution component into the PDLC process by calling the corresponding application programming interface; executing a data governance by association algorithm in response to embedding the data catalog, the data governance tool, the CI/CD pipeline, and the scheme evolution component into the PDLC process; and updating the data catalog with schemas based on the data governance by association algorithm, wherein each data producer and data consumer in connection with the developing, the testing, and the production of the application manages the data governance in synchronization during execution of the each identified phases of the PDLC process.

In some embodiments according to the non-transitory computer readable medium, the data governance tool may implement the data governance by association algorithm to ensure accountability and highlight dependencies among the data producer and the data consumer based on the metadata.

In some embodiments, in implementing the data governance by association algorithm, the instructions, when executed, may cause the processor to further perform the following: updating the data catalog in corresponding identified phases of the PDLC process in accordance with the schema and the metadata; and aligning control procedures around the data governance with the PDLC process based on the updated data catalog.

In some embodiments, the instructions, when executed, may cause the processor to further perform the following: automatically ingesting data from upstream domains of the PDLC process corresponding to the aligned control procedures.

In some embodiments, the instructions, when executed, may cause the processor to further perform the following: automatically updating the schema, by calling the schema evolution component via an application programming interface, corresponding to the updated data catalog based on the ingested data from the upstream domains of the PDLC process, thereby ensuring data security and protecting the PDLC process from malicious data breach.

In some embodiments, in implementing the CI/CD pipeline, the instructions, when executed, may cause the processor to further perform the following: merging code changes corresponding to the schema identified in the data catalog into a central repository; and calling the central repository via a corresponding application programming interface to retrieve the code changes for utilizing in an identified phase of the PDLC process.

In some embodiments, the instructions, when executed, may cause the processor to further perform the following: automatically releasing updates into the development phase, the testing phase, and the production phase of the PDLC process.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic automated data governance module configured for automatic data governance by association in a PDLC process in accordance with an embodiment.

FIG. 2 illustrates a diagram of a network environment with a platform, language, database, and cloud agnostic automated data governance device in accordance with an embodiment.

FIG. 3 illustrates a system diagram for implementing a platform, language, database, and cloud agnostic automated data governance device having a platform, language, database, and cloud agnostic automated data governance module in accordance with an embodiment.

FIG. 4 illustrates a system diagram for implementing a platform, language, database, and cloud agnostic automated data governance module of FIG. 3 in accordance with an embodiment.

FIG. 5 illustrates a flow chart of a process implemented by the platform, language, database, and cloud agnostic automated data governance module of FIG. 4 for automatic data governance by association in a PDLC process in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, conventional tools for data governance typically face multiple challenges. For example, control procedures around data governance are misaligned with a PDLC process; each producer/consumer manages data governance separately; sprint teams (a team of members essentially breaking down a larger software development project into manageable chunks and delivering incremental progress) face extra churn, i.e., adding, deleting, or modifying tasks after an initial commitment phase of the sprint, due to lack of information on data sources, classification, and definitions, leading to work spillover, etc.

As discussed earlier, conventional tools for data governance also face multiple challenges with respect to schema evolution issues. For example, with schema-on-write, producers may write to a predetermined schema but choose a version based on development progress; consumers may upgrade at their own pace, making it more like schema-on-read, leading to potential mismatches and integration challenges.

The present disclosure, through one or more of its various aspects, embodiments, and/or specific features or sub-components, provides, among other features, various systems, servers, devices, methods, media, programs, and platforms for implementing a platform, language, cloud, and database agnostic automated data governance module configured for integrating controls into the PDLC process with a focus on a shift-left approach, embedding the governance process into the PDLC process to ensure accountability and highlight dependencies, automatically streamlining data governance by implementing a business tech process of “governance by association”, updating a data catalog upfront with schemas based on the “governance by association,” etc., but the disclosure is not limited thereto.

Thus, the automated data governance device disclosed herein results in technological improvements to conventional data governance tools in that the automated data governance device disclosed herein may be configured to: align control procedures around data governance with the PDLC process; align overall business goals and compliance with regulations, rather than relying solely on a centralized authority to dictate governance; ensure that everyone involved in the PDLC process has a shared responsibility in upholding quality and best practices; provide definition of ready for sprint teams indicating governance information is already available; allow sprint teams to complete work efficiently and automate data ingestion from upstream domains, automate upgrades for new versions, eliminate change tickets in a consumer data lake, support for auto schema evolution, etc., but the disclosure is not limited thereto, thereby improving data security and protecting the overall systems from malicious cyber-attacks.

Although the processes as disclosed herein utilized PDLC, the processes as disclosed herein may be utilized in other use cases, such as medical records data processing, student records data processing, employee records data processing, or other business processes in consistent with the automatic data governance by association processes as disclosed herein.

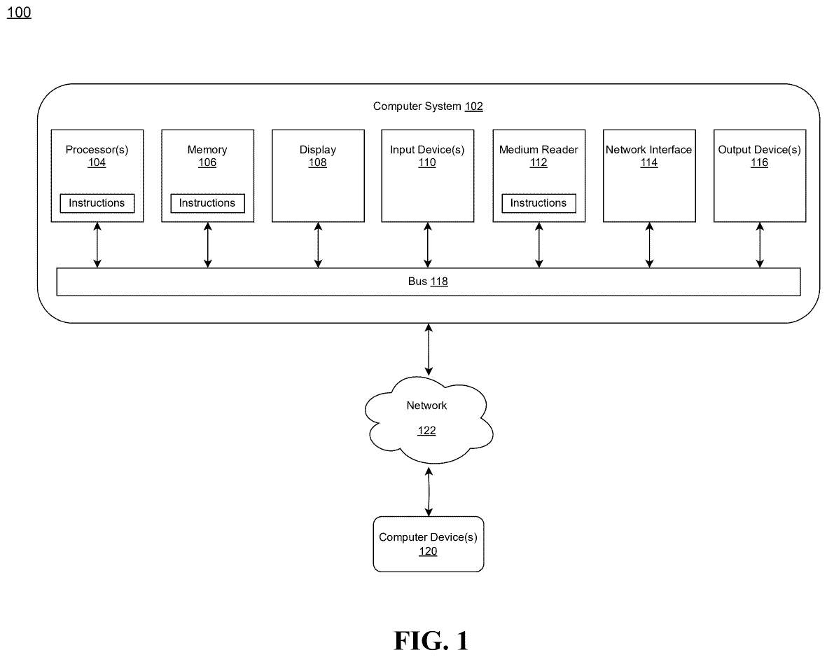

FIG. 1 is an exemplary system 100 for use in implementing a platform, language, database, and cloud agnostic automated data governance module configured for integrating controls into the PDLC process with a focus on a shift-left approach, embedding the governance process into the PDLC process to ensure accountability and highlight dependencies, automatically streamline data governance by implementing a business tech process of “governance by association”, and updating a data catalog upfront with schemas based on the “governance by association,” in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the automated data governance module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the automated data governance module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

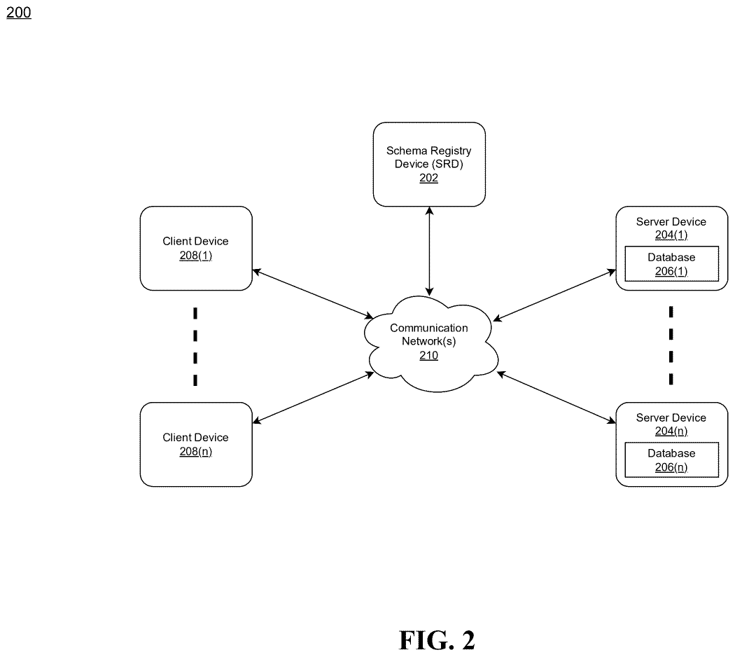

Referring to FIG. 2, a schematic of an exemplary network environment 200 for implementing a language, platform, database, and cloud agnostic automated data governance device (ADGD) of the instant disclosure is illustrated.

In some embodiments, the above-described problems associated with conventional tools may be overcome by implementing an ADGD 202 as illustrated in FIG. 2 that may be configured for implementing a platform, language, database, and cloud agnostic automated data governance module configured for integrating controls into the PDLC process with a focus on a shift-left approach, embedding the governance process into the PDLC process to ensure accountability and highlight dependencies, automatically streamline data governance by implementing a business tech process of “governance by association”, updating a data catalog upfront with schemas based on the “governance by association,” but the disclosure is not limited thereto.

The ADGD 202 may have one or more computer system 102s, as described with respect to FIG. 1, which in aggregate provide the necessary functions.

The ADGD 202 may store one or more applications that may include executable instructions that, when executed by the ADGD 202, cause the ADGD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ADGD 202 itself, may be located in virtual server(s) running in a cloud-based computing environment rather than being tied to one or more specific physical network computing devices. Also, the application(s) may be running in one or more virtual machines (VMs) executing on the ADGD 202. Additionally, in one or more embodiments of this technology, virtual machine(s) running on the ADGD 202 may be managed or supervised by a hypervisor.

In the network environment 200 of FIG. 2, the ADGD 202 may be coupled to a plurality of server devices 204(1)-204(n) that hosts a plurality of databases 206(1)-206(n), and also to a plurality of client devices 208(1)-208(n) via communication network(s) 210. A communication interface of the ADGD 202, such as the network interface 114 of the computer system 102 of FIG. 1, operatively couples and communicates between the ADGD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ADGD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The ADGD 202 may be a standalone device or integrated with one or more other devices or apparatuses, such as one or more of the server devices 204(1)-204(n). In some embodiments, the ADGD 202 may be hosted by one of the server devices 204(1)-204(n), and other arrangements may also be possible. Moreover, one or more of the devices of the ADGD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the ADGD 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the ADGD 202 that may efficiently provide a platform for implementing a platform, language, database, and cloud agnostic automated data governance module configured for integrating controls into the PDLC process with a focus on a shift-left approach, embedding the governance process into the PDLC process to ensure accountability and highlight dependencies, automatically streamline data governance by implementing a business tech process of “governance by association”, updating a data catalog upfront with schemas based on the “governance by association,” etc., but the disclosure is not limited thereto.

The client devices 208(1)-208(n) may run interface applications, such as standard web browsers or standalone client applications, which may provide an interface to communicate with the ADGD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the ADGD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the ADGD 202, the server devices 204(1)-204(n), or the client devices 208(1)-208(n), in some embodiments, may be configured to operate as virtual instances on the same physical machine. In some embodiments, one or more of the ADGD 202, the server devices 204(1)-204(n), or the client devices 208(1)-208(n) may operate on the same physical device rather than as separate devices communicating through communication network(s) 210. Additionally, there may be more or fewer ADGDs 202, server devices 204(1)-204(n), or client devices 208(1)-208(n) than illustrated in FIG. 2. In some embodiments, the ADGD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

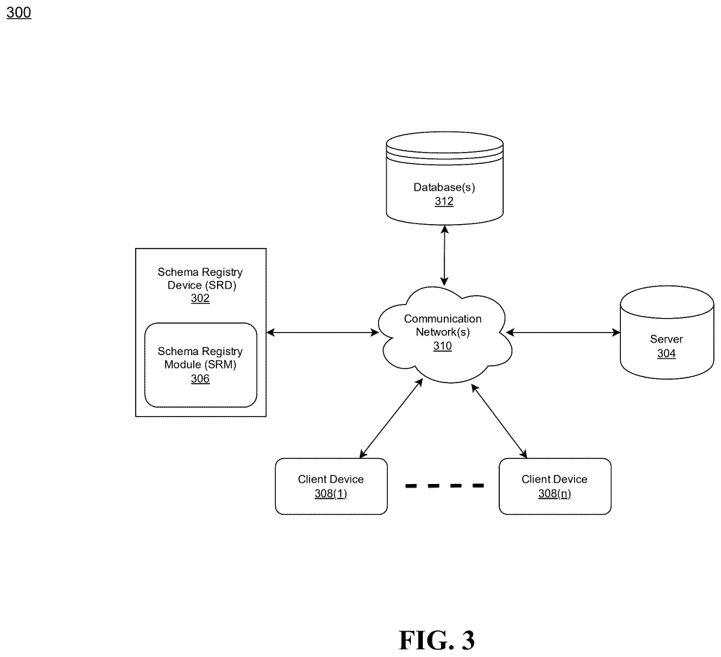

FIG. 3 illustrates a system diagram for implementing a platform, language, and cloud agnostic ADGD having a platform, language, database, and cloud agnostic automated data governance module (ADGM) in accordance with an embodiment.

As illustrated in FIG. 3, the system 300 may include an ADGD 302 within which an ADGM 306 may be embedded, a server 304, a database(s) 312, a plurality of client devices 308(1) . . . 308(n), and a communication network 310.

In some embodiments, the ADGD 302 including the ADGM 306 may be connected to the server 304, and the database(s) 312 via the communication network 310. The ADGD 302 may also be connected to the plurality of client devices 308(1) . . . 308(n) via the communication network 310, but the disclosure is not limited thereto.

According to exemplary embodiment, the ADGD 302 is described and shown in FIG. 3 as including the ADGM 306, although it may include other rules, policies, modules, databases, or applications, etc. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto.

In some embodiments, the ADGM 306 may be configured to receive real-time feed of data from the plurality of client devices 308(1) . . . 308(n) and secondary sources via the communication network 310.

As may be described below, the ADGM 306 may be configured to: identify phases of the PDLC process as a development phase, followed by a testing phase, and followed by a production phase corresponding to developing, testing, and production of an application, respectively; create, for each identified phases of the PDLC process, corresponding data catalog that includes metadata identifying what information to be collected, by whom, and at what stage of each identified phase of the PDLC process corresponding to the application; establish a communication link among the data catalog, a data governance tool, a CI/CD pipeline, and a schema evolution component via calling corresponding application programming interface; embed the data catalog, the data governance tool, the CI/CD pipeline, and the scheme evolution component into the PDLC process by calling the corresponding application programming interface; execute a data governance by association algorithm in response to embedding the data catalog, the data governance tool, the CI/CD pipeline, and the scheme evolution component into the PDLC process; and update data catalog with schemas based on the data governance by association algorithm, wherein each data producer and data consumer in connection with the developing, the testing, and the production of the application manages data governance in synchronization during execution of the each identified phases of the PDLC process, etc., but the disclosure is not limited thereto.

The plurality of client devices 308(1) . . . 308(n) are illustrated as being in communication with the ADGD 302. In this regard, the plurality of client devices 308(1) . . . 308(n) may be “clients” (e.g., customers) of the ADGD 302 and are described herein as such. Nevertheless, it is to be known and understood that the plurality of client devices 308(1) . . . 308(n) need not necessarily be “clients” of the ADGD 302, or any entity described in association therewith herein. Any additional or alternative relationship may exist between either or both of the plurality of client devices 308(1) . . . 308(n) and the ADGD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the ADGD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The ADGD 302 may be the same or similar to the ADGD 202 as described with respect to FIG. 2, including any features or combination of features described with respect thereto.

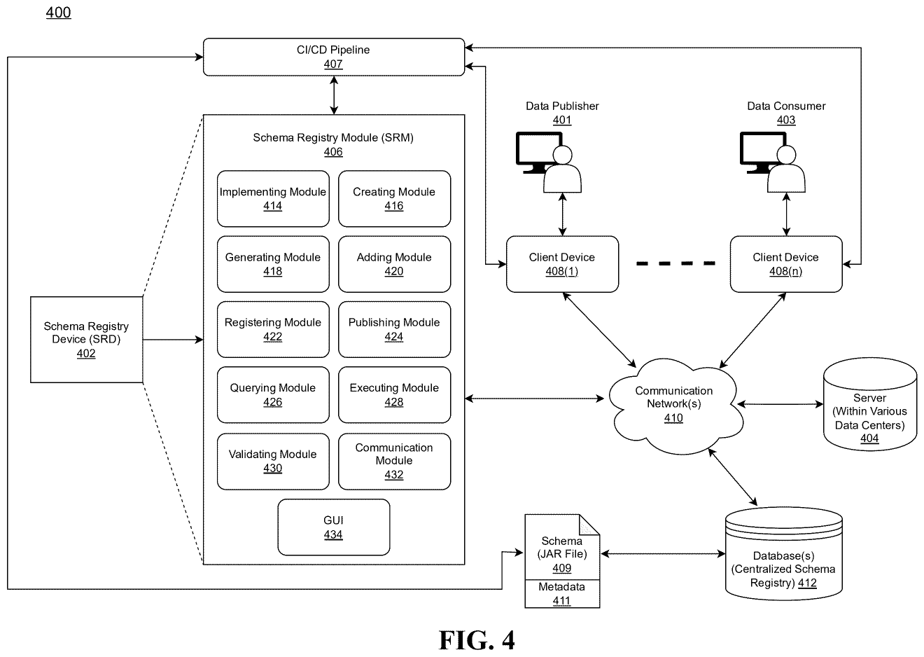

FIG. 4 illustrates a system diagram for implementing a platform, language, database, and cloud agnostic ADGM of FIG. 3 in accordance with an exemplary embodiment.

In some embodiments, the system 400 may include a platform, language, database, and cloud agnostic ADGD 402 within which a platform, language, database, and cloud agnostic ADGM 406 may be embedded, a server 404, a PDLC process 407, a data catalog 415 (i.e., a database acting as a system of record for a particular data or schema having metadata), a data governance tool 417, a CI/CD pipeline 419, a schema evaluation component 421, and a database(s) 412 (may also be referred to as a central repository), and a communication network 410. In some embodiments, server 404 may comprise a plurality of servers located centrally or located in different locations, but the disclosure is not limited thereto.

In some embodiments, the ADGD 402 including the ADGM 406 may be connected to the server 404, the PDLC process 407, the data catalog 415, the data governance tool 417, the CI/CD pipeline 419, the schema evaluation component 421, and the database(s) 412 via the communication network 410 thereby creating distributed multi-cloud application environments. The ADGD 402 may also be connected to the plurality of client devices 408(1)-408(n) via the communication network 410, but the disclosure is not limited thereto. The ADGM 406, the server 404, the plurality of client devices 408(1)-408(n), the database(s) 412, the communication network 410 as illustrated in FIG. 4 may be the same or similar to the ADGM 306, the server 304, the plurality of client devices 308(1)-308(n), the database(s) 312, the communication network 310, respectively, as illustrated in FIG. 3.

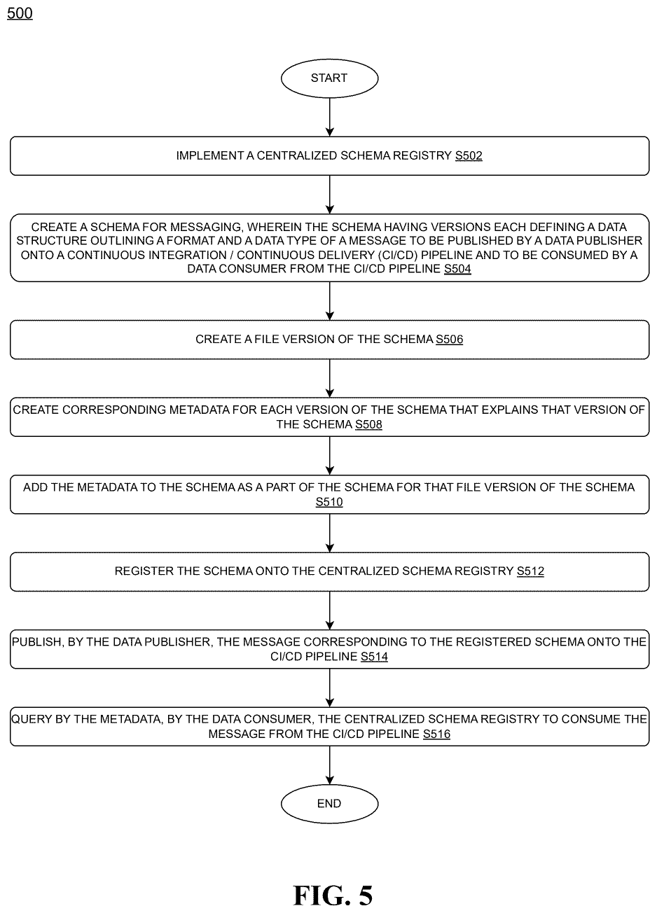

In some embodiments, as illustrated in FIG. 4, the ADGM 406 may include an identifying module 414, a creating module 416, an embedding module 418, an executing module 420, an updating module 422, an aligning module 424, an ingesting module 426, a merging module 428, a calling module 430, a communication module 432, and a Graphical User Interface (GUI) 434. In some embodiments, interactions and data exchange among these modules included in the ADGM 406 provide the advantageous effects of the disclosed invention. Functionalities of each module of FIG. 4 may be described in detail below with reference to FIGS. 4-5.

In some embodiments, each of the identifying module 414, the creating module 416, the embedding module 418, the executing module 420, the updating module 422, the aligning module 424, the ingesting module 426, the merging module 428, the calling module 430, and the communication module 432 of the ADGM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the identifying module 414, the creating module 416, the embedding module 418, the executing module 420, the updating module 422, the aligning module 424, the ingesting module 426, the merging module 428, the calling module 430, and the communication module 432 of the ADGM 406 of FIG. 4 may be implemented by microprocessors or similar, and may be programmed using software (e.g., microcode) to perform various functions discussed herein and may optionally be driven by firmware and/or software.

Alternatively, in some embodiments, each of the identifying module 414, the creating module 416, the embedding module 418, the executing module 420, the updating module 422, the aligning module 424, the ingesting module 426, the merging module 428, the calling module 430, and the communication module 432 of the ADGM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the ADGM 406 of FIG. 4 may also be implemented by cloud-based deployment.

In some embodiments, each of the identifying module 414, the creating module 416, the embedding module 418, the executing module 420, the updating module 422, the aligning module 424, the ingesting module 426, the merging module 428, the calling module 430, and the communication module 432 of the ADGM 406 of FIG. 4 may be called via corresponding API, but the disclosure is not limited thereto. For example, in some embodiments, the identifying module 414 may be called via a first API, the creating module 416 may be called via a second API, the embedding module 418 may be called via a third API, the executing module 420 may be called via a fourth API, the updating module 422 may be called via a fifth API, the aligning module 424 may be called via a sixth API, the ingesting module 426 may be called via a seventh API, the merging module 428 may be called via an eight API, the calling module 430 may be called via a ninth API, and the communication module 432 may be called via a tenth API. In some embodiments, calls may also be made using event-based message interfaces in addition to APIs. An event-based message interface may be a design pattern that enables communication between services by defining events and handlers that process them. This approach may allow for efficient communication and decoupled components, which may lead to more flexible and modular systems.

In some embodiments, the process implemented by the ADGM 406 may be executed via the communication module 432, and the communication network 410, which may comprise plural networks as described above. In some embodiments, the various components of the ADGM 406 may communicate with the server 404, the data catalog 415, the data governance tool 417, the CI/CD pipeline 419, the schema evaluation component 421, and the database(s) 412 via the communication module 432 and the communication network 410 and the results may be displayed onto the GUI 434. Of course, these embodiments are merely exemplary and are not limiting or exhaustive. The database(s) 412 may include the databases included within the private cloud and/or public cloud and the server 404 may include one or more servers within the private cloud and the public cloud.

As will be disclosed below, in some embodiments, the ADGM 406 may be configured for integrating controls into the PDLC process 407 with a focus on a shift-left approach, embedding the governance process into the PDLC process 407 to ensure accountability and highlight dependencies, automatically streamlining data governance by implementing a business tech process of “governance by association”, updating the data catalog 415 upfront with schemas based on the “governance by association,” etc., but the disclosure is not limited thereto.

Thus, the ADGM 406 disclosed herein results in technological improvements to conventional data governance tools in that the ADGM 406 disclosed herein may be configured to: align control procedures around data governance with the PDLC process; align overall business goals and compliance with regulations, rather than relying solely on a centralized authority to dictate governance; ensure that everyone involved in the PDLC process 407 has a shared responsibility in upholding quality and best practices; provide definition of ready for sprint teams indicating governance information is already available; allow sprint teams to complete work efficiently and automate data ingestion from upstream domains, automate upgrades for new versions, eliminate change tickets in a consumer data lake, support for auto schema evolution, etc., but the disclosure is not limited thereto, thereby improving data security and protecting the overall system 400 from malicious cyber-attacks.

For example, FIG. 5 illustrates a flow chart of the process 500 implemented by the ADGM 405 of FIG. 4 for automatic data governance by association in the PDLC process 407 in accordance with an embodiment. It may be appreciated that the illustrated process 500 and associated steps may be performed in a different order, with illustrated steps omitted, with additional steps added, or with a combination of reordered, combined, omitted, or additional steps.

Referring to FIGS. 4-5, in some embodiments, at step S502, the process 500 may include identifying, by calling the identifying module 414 via a first API, identifying phases of the PDLC process as a development phase 409, followed by a testing phase 411, and followed by a production phase 413 corresponding to developing, testing, and production of an application, respectively.

For example, with respect to software/application development, the identifying module 414 may model current applications and associated PDLC phases of the PDLC process 407 (i.e., development phase 409, followed by the testing phase 411, and followed by the production phase 413) to determine what infrastructure environments would be required or preferred. This may include defining security, privacy, management or other profiles for each SDLC phase of each application within the phases PDLC process 407. The profiles, in turn, may identify infrastructure and systems, for example, the server 404, the data catalog 415 (i.e., a database acting as a system of record for a particular data or schema having metadata), the data governance tool 417, the CI/CD pipeline 419, the schema evaluation component 421, and the database(s) 412, that support the PDLC phases of the PDLC process 407, and manage relationships between the infrastructure, systems and the applications. In some embodiments, profiles may also contain characteristics regarding the PDLC phases of the PDLC process 407 or attributes relevant to development, deployment or performance of infrastructure, systems, or workloads, such as latency, geography, responsiveness, bandwidth, storage capacity, processing speed, processing type, platforms involved (including operating system, file types, communication protocols, and the like), data involved, protocols used, and specific institutional requirements.

In terms of prioritizing the cloud-computing services needed for the PDLC phases of the PDLC process 407, the identifying module 414 may first identify which PDLC computing environments and systems would be suitable for cloud computing or migration to cloud computing, and then prioritize the enablement and operability of newly developed or migrated computer workloads according to the PDLC phases of the PDLC process 407.

In some embodiments, at step S504, the process 500 may include creating, by calling the creating module 415 via the second API, for each identified phases, i.e., developing phase 409, testing phase 411, and the production phase 413 of the PDLC process 407, corresponding data catalog 415 that includes metadata identifying what information to be collected, by whom, and at what stage of each identified phase of the PDLC process 407 corresponding to the application.

In some embodiments, the metadata may be represented as a metadata matrix in a table format having a plurality of columns and rows. For example, a column may represent metadata attributes in connection with the development, testing and production of the application in the PDLC process 407. The metadata attributes may include physical name, business, first data owner (i.e., a cloud-native data governance platform which provides data associated with unique identifier and create policy), a second data owner (i.e., other data sources identified via unique identifier), subject matter expert (data scientists/feature product owner who generates the source data), system of record or authoritative data source (created or maintained), enterprise software platform that helps an organization meet its governance, risk and compliance goals quickly, even as requirements constantly change by utilizing a data model making it inherently adaptable (i.e., entitlement), column sequence (order of column in a data stream or a data file), frequency (real-time, intraday, daily, monthly, etc.), file type (messaging or batch - full or incremental), line of business indicator, field that leveraged for retention of data, data type (string, date, numeric, etc.), valid values (limited set of values (content)), formula (derived values created by analytics), tags (logical concepts used to create policies), schema (source schema along with data source), business description (i.e., human insight), data offerings (as set of digital information that may be purchased by a client or consumed by an internal function, a regulator or external market infrastructure, data products (broad, cohesive collections of related data aligned to business functions and goals; contains a collection of data offerings), data concepts (boundary sets (e.g. fiscal year or trade) or other organizing or collection dimensions), etc., but the disclosure is not limited thereto.

In some embodiments, another set of columns of the metadata matrix may represent inter domain—up front features for Product Backlog Refinement (PBR), such as, “where,” “responsible parties,” “accountable parties,” “consulted parties,” and “informed parties” involved in developing, testing, and production phase of the PDLC process 407 in connection with the development, testing and production of the application in the PDLC process 407. PBR is the regular activity carried by most or all of the team in the PDLC process 407 with the goal of preparing activities for upcoming iteration(s). The key activities may involve: clarifying user stories, so that the team has a common understanding of them; splitting stories that are too large to fit in an iteration; creating new user stories and removing others according to new knowledge; assigning estimates to stories; assigning priorities to stories, etc., in consistent with the data governance process implemented by the ADGM 406.

In some embodiments, another set of columns of the metadata matrix may represent intra domain—PBR (sprint team) and DOR (Definition of Ready; allows a user to evaluate work before the sprint team starts on it)) for sprint team to start. For example, the DOR for (raw/trusted) may also include “where,” “responsible parties,” “accountable parties,” “consulted parties,” and “informed parties” involved in developing, testing, and production phase of the PDLC process 407 in connection with the development, testing and production of the application in the PDLC process 407.

In some embodiments, another set of columns of the metadata matrix may represent sprint team and DOD (Definition of Done). For example, the DOD (refiner) may also include “where,” “responsible parties,” “accountable parties,” “consulted parties,” and “informed parties,” and additionally, tactical/strategic features involved in developing, testing, and production phase of the PDLC process 407 in connection with the development, testing and production of the application in the PDLC process 407. DOD is a set of criteria that defines when a product increment is complete. DOD is a shared understanding of when a product increment is ready for release. It's a list of deliverables that act as benchmarks for a project. DOD helps ensure quality, minimize risk, improve team alignment, and measure progress. In some embodiments, in implementing the DOD process, the ADGM 406 may create a checklist of activities that add verifiable value to the product. It applies to every work item that involves code, but not everything on the checklist needs to be ticked off for every item. The DOD is not static and changes over time. Organizational support and the sprint team's ability to remove impediments may enable the inclusion of additional activities.

For example, in some embodiments, at step S506, the process 500 implemented by the ADGM 405 of FIG. 4 may include establishing, by calling the communication module 432 via the tenth API, a communication link among the data catalog 415, the data governance tool 417, the CI/CD pipeline 419, and the schema evolution component 421 via calling corresponding application programming interface by utilizing the calling module 430.

In some embodiments, at step S508, the process 500 implemented by the ADGM 405 of FIG. 4 may include, embedding, by calling the embedding module 420 via the third API, the data catalog 415, the data governance tool 417, the CI/CD pipeline 419, and the schema evolution component 421 into the PDLC process 407 by calling corresponding application programming interface via the calling module 430.

In some embodiments, in implementing the CI/CD pipeline 419, at step S508 of the process 500 implemented by the ADGM 405 of FIG. 4 may further include merging, by calling the merging module 428 via the eight API, code changes corresponding to the schema identified in the data catalog 415 into a central repository (i.e., database(s) 412); and calling, by utilizing the calling module 430, the central repository via a corresponding application programming interface to retrieve the code changes for utilizing in an identified phase of the PDLC process 407. The process 500 may then automatically release updates into the development phase 409, the testing phase 411, and the production phase 413 of the PDLC process 407.

In some embodiments, at step S510, the process 500 implemented by the ADGM 405 of FIG. 4 may also include executing, by calling the executing module 424 via the fourth API, a data governance by association algorithm in response to embedding the data catalog 415, the data governance tool 417, the CI/CD pipeline 419, and the schema evolution component 421 into the PDLC process 407.

In some embodiments, the data governance tool 417 may be configured to implement the data governance by association algorithm to ensure accountability and highlight dependencies among the data producer and the data consumer based on the metadata discussed earlier.

For example, in some embodiments, in implementing the data governance by association algorithm by the data governance tool 417, at step S510, the process 500 implemented by the ADGM 405 of FIG. 4 may also include, updating, by calling the updating module 422 via the fifth API, the data catalog 415 in corresponding identified phases of the PDLC process 407 in accordance with the schema and the metadata discussed earlier; and aligning, by calling the aligning module 424 via the sixth API, control procedures identified in the metadata around data governance with the PDLC process 407 based on the updated data catalog 415.

In some embodiments, in implementing the data governance by association algorithm by the data governance tool 417, at step S510, the process 500 implemented by the ADGM 405 of FIG. 4 may also include automatically ingesting, by calling the ingesting module 426 via the seventh API, data from upstream domains of the PDLC process 407 corresponding to the aligned control procedures.

In some embodiments, in implementing the data governance by association algorithm by the data governance tool 417, at step S510, the process 500 implemented by the ADGM 405 of FIG. 4 may also include automatically updating the schema, by calling the schema evolution component 421 via the updating module 422, corresponding to the updated data catalog 415 based on the ingested data from the upstream domains of the PDLC process 407, thereby ensuring data security and protecting the PDLC process from malicious data breach.

For example, the ADGM 406 may be configured to manage thousands of schema versions discussed earlier across a plurality of clusters in various geographic regions. Moreover, integration of the schema evolution component 421 and the security implementation mentioned earlier enables locking down data sets based on data product/product line. In addition, automation of schema evolution component 421 on the consumer side is fully implemented, resulting in savings of hundreds of changes across hundreds of schemas thereby significantly improving processing speed of the PDLC process 407.

In some embodiments, creating the data catalog 415 that identifies what information to be collected, by whom, and at what stage of the PDLC process 407 corresponding to developing, testing, and production of the application, ensures that the business requirement is available, and for that business requirement, this set of information has to be collected at this specific point of time. For example, the first a data modeling tool (i.e., relational database) that becomes a system of record for that metadata for that particular dataset which is mentioned in the data catalog 407 and based on the integration of the first data modeling tool to the CI/CD pipeline 419. From there, another option of catalog—meaning the PDLC process 407 sends this information from the first data modeling tool to this catalog and ensures that it versioned over there over time in the catalog itself. The versioning may be performed by transmitting the output of the first data modeling tool through the CI/CD pipeline 419 to the catalog, by using the first data modeling tool and a central repository (i.e., database(s) 412), thereby ensuring that a publisher may not publish to anything else except for the schema that has been given there. Data consumer is completely delinked and upgrading at its own pace by itself—no manual intervention is necessary.

Thus, when the data consumer reads the message via the CI/CD pipeline 419, it is able to get the schema, and the metadata mentioned earlier along with it, and it may upgrade by itself. That is, the data consumer may apply all the controls features identified in the meta data matrix discussed earlier on the data it is receiving out of the box, not just upgrading to the schema, but applying all the predefined controls protection groups on the attributes.

For example, in some embodiments, at step S512 of the process 500 implemented by the ADGM 405 of FIG. 4 may further include updating, by calling the updating module 422 via the fifth API, data catalog 415 with schemas based on the data governance by association algorithm. Each data producer and data consumer in connection with the developing, the testing, and the production of the application manages the data governance in synchronization during execution of the each identified phases of the PDLC process 407.

In some embodiments, the metadata identified in the metadata matrix mentioned earlier, including policy information, may be associated with the workload such that throughout the various components of the PDLC process 407, from planning through deployment to a cloud or other sources, the PDLC process 407 may be handled in a manner that is consistent with the metadata, and in particular consistent with the policies that are applicable to that workload. For example, the user may utilize the ADGM 406 to plan the use of workloads in a manner that is consistent with technical, operational, and business requirements that are appropriate with such workload, as seen by association of the same with the workload, and the user may modify or populate the policies associated with the workload, such that the metadata for that workload embodies and is consistent with the plans of the user. Once associated with the workload, such policies and other metadata may be stored by the PDLC process 407 into a central repository (i.e., database(s) 412), and may be used throughout the development, testing, and deployment cycle of the PDLC process 407.

In some embodiments, the ADGD 402 may include a memory (e.g., a memory 106 as illustrated in FIG. 1) which may be a non-transitory computer readable medium that may be configured to store instructions for implementing a platform, language, database, and cloud agnostic ADGM 406 for automated data governance in a PDLC process as disclosed herein. The ADGD 402 may also include a medium reader (e.g., a medium reader 112 as illustrated in FIG. 1) which may be configured to read any one or more sets of instructions, e.g., software, from any of the memories described herein. The instructions, when executed by a processor embedded within the ADGM 406 or within the ADGD 402, may be used to perform one or more of the processes as described herein. In a particular embodiment, the instructions may reside completely, or at least partially, within the memory 106, the medium reader 112, and/or the processor 104 (see FIG. 1) during execution by the ADGD 402.

In some embodiments, the instructions, when executed, may cause a processor embedded within the ADGM 406 or the ADGD 402 to perform the following: identifying phases of the PDLC process as a development phase, followed by a testing phase, and followed by a production phase corresponding to developing, testing, and production of an application, respectively; creating, for each identified phases of the PDLC process, corresponding data catalog that includes metadata identifying what information to be collected, by whom, and at what stage of each identified phase of the PDLC process corresponding to the application; establishing a communication link among the data catalog, a data governance tool, a CI/CD pipeline, and a schema evolution component via calling corresponding application programming interface; embedding the data catalog, the data governance tool, the CI/CD pipeline, and the scheme evolution component into the PDLC process by calling the corresponding application programming interface; executing a data governance by association algorithm in response to embedding the data catalog, the data governance tool, the CI/CD pipeline, and the scheme evolution component into the PDLC process; and updating data catalog with schemas based on the data governance by association algorithm, wherein each data producer and data consumer in connection with the developing, the testing, and the production of the application manages data governance in synchronization during execution of the each identified phases of the PDLC process, but the disclosure is not limited thereto. For example, the features values may represent other data as disclosed above. In some embodiments, the processor may be the same or similar to the processor 104 as illustrated in FIG. 1 or the processor embedded within the ADGD 202, ADGD 302, ADGD 402, and ADGM 406 which may be the same or similar to the processor 104.

In some embodiments according to the non-transitory computer readable medium, the data governance tool may implement the data governance by association algorithm to ensure accountability and highlight dependencies among the data producer and the data consumer based on the metadata.

In some embodiments, in implementing the data governance by association algorithm, the instructions, when executed, may cause the processor 104 to further perform the following: updating the data catalog in corresponding identified phases of the PDLC process in accordance with the schema and the metadata; and aligning control procedures around data governance with the PDLC process based on the updated data catalog.

In some embodiments, the instructions, when executed, may cause the processor 104 to further perform the following: automatically ingesting data from upstream domains of the PDLC process corresponding to the aligned control procedures.

In some embodiments, the instructions, when executed, may cause the processor 104 to further perform the following: automatically updating the schema, by calling the schema evolution component via an application programming interface, corresponding to the updated data catalog based on the ingested data from the upstream domains of the PDLC process, thereby ensuring data security and protecting the PDLC process from malicious data breach.

In some embodiments, in implementing the CI/CD pipeline, the instructions, when executed, may cause the processor 104 to further perform the following: merging code changes corresponding to the schema identified in the data catalog into a central repository; and calling the central repository via a corresponding application programming interface to retrieve the code changes for utilizing in an identified phase of the PDLC process.

In some embodiments, the instructions, when executed, may cause the processor 104 to further perform the following: automatically releasing updates into the development phase, the testing phase, and the production phase of the PDLC process.

In some embodiments as disclosed above in FIGS. 1-5, technical improvements effected by the instant disclosure may include a platform for implementing a platform, language, database, and cloud agnostic automated data governance module configured for integrating controls into the PDLC process with a focus on a shift-left approach, embedding the governance process into the PDLC process to ensure accountability and highlight dependencies, automatically streamline data governance by implementing a business tech process of “governance by association”, updating a data catalog upfront with schemas based on the “governance by association,” etc., but the disclosure is not limited thereto.

Thus, the automated data governance module disclosed herein with reference to FIGS. 1-5 results in technological improvements to conventional data governance tools in that the automated data governance module disclosed herein may be configured to: align control procedures around data governance with the PDLC process; align overall business goals and compliance with regulations, rather than relying solely on a centralized authority to dictate governance; ensure that everyone involved in the PDLC process has a shared responsibility in upholding quality and best practices; provide definition of ready for sprint teams indicating governance information is already available; allow sprint teams to complete work efficiently and automate data ingestion from upstream domains, automate upgrades for new versions, eliminate change tickets in a consumer data lake, support for auto schema evolution, etc., but the disclosure is not limited thereto, thereby improving data security and protecting the overall systems from malicious cyber-attacks.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for automated data governance in a product development life cycle (PDLC) process by utilizing one or more processors along with allocated memory, the method comprising:
identifying phases of the PDLC process as a development phase, followed by a testing phase, and followed by a production phase corresponding to developing, testing, and production of an application, respectively;
creating a data catalog that includes metadata identifying what information to be collected, by whom, and at what stage of each identified phase of the PDLC process corresponding to the application;
establishing a communication link among the data catalog, a data governance tool, a continuous integration/continuous delivery (CI/CD) pipeline, and a schema evolution component via calling corresponding application programming interface;
embedding the data catalog, the data governance tool, the CI/CD pipeline, and the scheme evolution component into the PDLC process by calling the corresponding application programming interface;
executing a data governance by association algorithm in response to embedding the data catalog, the data governance tool, the CI/CD pipeline, and the scheme evolution component into the PDLC process; and
updating the data catalog with schemas based on the data governance by association algorithm, wherein each data producer and data consumer in connection with the developing, the testing, and the production of the application manages the data governance in synchronization during execution of the each identified phases of the PDLC process.

2. The method of claim 1, wherein the data governance tool implements the data governance by association algorithm to ensure accountability and highlight dependencies among the data producer and the data consumer based on the metadata.

3. The method of claim 2, wherein in implementing the data governance by association algorithm, the method further comprising:
updating the data catalog in corresponding identified phases of the PDLC process in accordance with the schema and the metadata; and
aligning control procedures around the data governance with the PDLC process based on the updated data catalog.

4. The method of claim 3, further comprising:
automatically ingesting data from upstream domains of the PDLC process corresponding to the aligned control procedures.

5. The method of claim 4, further comprising:
automatically updating the schema, by calling the schema evolution component via an application programming interface, corresponding to the updated data catalog based on the ingested data from the upstream domains of the PDLC process, thereby ensuring data security and protecting the PDLC process from malicious data breach.

6. The method of claim 1, wherein in implementing the CI/CD pipeline, the method further comprising:
merging code changes corresponding to the schema identified in the data catalog into a central repository; and
calling the central repository via a corresponding application programming interface to retrieve the code changes for utilizing in an identified phase of the PDLC process.

7. The method of claim 6, further comprising:
automatically releasing updates into the development phase, the testing phase, and the production phase of the PDLC process.

8. A system for automated data governance in a product development life cycle (PDLC) process by utilizing one or more processors along with allocated memory, the system comprising:
a processor; and
a memory operatively connected to the processor via a communication interface, the memory storing computer readable instructions, when executed, causes the processor to:
identify phases of the PDLC process as a development phase, followed by a testing phase, and followed by a production phase corresponding to developing, testing, and production of an application, respectively;
create a data catalog that includes metadata identifying what information to be collected, by whom, and at what stage of each identified phase of the PDLC process corresponding to the application;
establish a communication link among the data catalog, a data governance tool, a continuous integration/continuous delivery (CI/CD) pipeline, and a schema evolution component via calling corresponding application programming interface;
embed the data catalog, the data governance tool, the CI/CD pipeline, and the scheme evolution component into the PDLC process by calling the corresponding application programming interface;
execute a data governance by association algorithm in response to embedding the data catalog, the data governance tool, the CI/CD pipeline, and the scheme evolution component into the PDLC process; and
update the data catalog with schemas based on the data governance by association algorithm, wherein each data producer and data consumer in connection with the developing, the testing, and the production of the application manages the data governance in synchronization during execution of the each identified phases of the PDLC process.

9. The system of claim 8, wherein the data governance tool implements the data governance by association algorithm to ensure accountability and highlight dependencies among the data producer and the data consumer based on the metadata.

10. The system of claim 9, wherein in implementing the data governance by association algorithm, the processor is further configured to:
update the data catalog in corresponding identified phases of the PDLC process in accordance with the schema and the metadata; and
align control procedures around the data governance with the PDLC process based on the updated data catalog.

11. The system of claim 10, wherein the processor is further configured to:
automatically ingest data from upstream domains of the PDLC process corresponding to the aligned control procedures.

12. The system of claim 11, wherein the processor is further configured to:
automatically update the schema, by calling the schema evolution component via an application programming interface, corresponding to the updated data catalog based on the ingested data from the upstream domains of the PDLC process, thereby ensuring data security and protecting the PDLC process from malicious data breach.

13. The system of claim 8, wherein in implementing the CI/CD pipeline, the processor is further configured to:
merge code changes corresponding to the schema identified in the data catalog into a central repository; and
call the central repository via a corresponding application programming interface to retrieve the code changes for utilizing in an identified phase of the PDLC process.

14. The system of claim 13, wherein the processor is further configured to:
automatically release updates into the development phase, the testing phase, and the production phase of the PDLC process.

15. A non-transitory computer readable medium configured to store instructions for automated data governance in a product development life cycle (PDLC) process, the instructions, when executed, cause a processor to perform the following:
identifying phases of the PDLC process as a development phase, followed by a testing phase, and followed by a production phase corresponding to developing, testing, and production of an application, respectively;
creating a data catalog that includes metadata identifying what information to be collected, by whom, and at what stage of each identified phase of the PDLC process corresponding to the application;
establishing a communication link among the data catalog, a data governance tool, a continuous integration/continuous delivery (CI/CD) pipeline, and a schema evolution component via calling corresponding application programming interface;
embedding the data catalog, the data governance tool, the CI/CD pipeline, and the scheme evolution component into the PDLC process by calling the corresponding application programming interface;
executing a data governance by association algorithm in response to embedding the data catalog, the data governance tool, the CI/CD pipeline, and the scheme evolution component into the PDLC process; and
updating the data catalog with schemas based on the data governance by association algorithm, wherein each data producer and data consumer in connection with the developing, the testing, and the production of the application manages the data governance in synchronization during execution of the each identified phases of the PDLC process.

16. The non-transitory computer readable medium of claim 15, wherein the data governance tool implements the data governance by association algorithm to ensure accountability and highlight dependencies among the data producer and the data consumer based on the metadata.

17. The non-transitory computer readable medium of claim 16, wherein in implementing the data governance by association algorithm, the instructions, when executed, cause the processor to further perform the following:
updating the data catalog in corresponding identified phases of the PDLC process in accordance with the schema and the metadata; and
aligning control procedures around the data governance with the PDLC process based on the updated data catalog.

18. The non-transitory computer readable medium of claim 17, wherein the instructions, when executed, cause the processor to further perform the following:
automatically ingesting data from upstream domains of the PDLC process corresponding to the aligned control procedures.

19. The non-transitory computer readable medium of claim 18, wherein the instructions, when executed, cause the processor to further perform the following:
automatically updating the schema, by calling the schema evolution component via an application programming interface, corresponding to the updated data catalog based on the ingested data from the upstream domains of the PDLC process, thereby ensuring data security and protecting the PDLC process from malicious data breach.

20. The non-transitory computer readable medium of claim 15, wherein in implementing the CI/CD pipeline, the instructions, when executed, cause the processor to further perform the following:
merging code changes corresponding to the schema identified in the data catalog into a central repository; and
calling the central repository via a corresponding application programming interface to retrieve the code changes for utilizing in an identified phase of the PDLC process; and
automatically releasing updates into the development phase, the testing phase, and the production phase of the PDLC process.
